(19) United States
(12) Patent Application Publication
(10) Pub. No.: US 2024/0333841 A1
(43) Pub. Date: Oct. 3, 2024

(54) CONFIGURING CHARGING TRIGGERS USING NOTIFICATION MESSAGES

(71) Applicant: Telefonaktiebolaget LM Ericsson (publ), Stockholm (SE)

(72) Inventors: Narasimham SETTIPALLI, Chennai (IN); Chandrasekar KARTHIKEYAN, Chennai (IN); Tamilmani ARVINDH RAJESH, Chennai (IN); Venkataramanarao RAGHAVENDRAN, Chennai (IN)

(73) Assignee: Telefonaktiebolaget LM Ericsson (publ), Stockholm (SE)

(21) Appl. No.: 18/681,720

(22) PCT Filed: Aug. 10, 2021
(86) PCT No.: PCT/IN2021/050765

§ 371 Date: Feb. 6, 2024

(51) Int. Cl. H04M 15/00

(52) U.S. Cl. CPC H04M 15/62

(57) ABSTRACT

A method (400) is provided for assisting in a configuring of charging triggers in a Network Function (410), NF. The method is performed by a Converged Charging Function (120), CHF. The method includes sending a notification message (420) from the CHF to the NF, wherein the notification message at least indicates one or more charging triggers to be configured by the NF in accordance with the notification message. A corresponding method of configuring charging triggers in an NF includes receiving the notification message and configuring the charging triggers in accordance therewith. Corresponding entities, computer programs and computer program products are also provided.

### TECHNICAL FIELD

The present disclosure relates to the field of cellular networks. In particular, the present disclosure relates to the provisioning of charging triggers in such networks.

### BACKGROUND

In future fifth generation (5G) telecommunication architectures, network slicing is envisaged as being a default scenario for core network functions, radio access networks and e.g. end-to-end dedicated service enablement. For this purpose, a plurality of standardized network slice types is defined in System architecture specification 3GPP TS 23.501, including e.g. Enhanced Mobile Broadband (eMBB), Ultra Reliable Low Latency Communication (URLLC), Massive Internet-of-Things (MIOT), High-Performance Machine-Type Communications (HMTC), and Vehicle to anything (V2X) slices. Other, non-standard network slice types are also possible, including for example Critical IoT, Enterprise Network, Industrial IoT, or Mobile Virtual Network Operator (MVNO) slices.

In current architectures, charging triggers (as described in 3GPP TS 32.290/291) are reported in and configured using Charging control application responses. For example, a Network Function (NF) in form of a Session Management Function (SMF) may send a Charging Data Request [Initial or Update] to a Converged Charging Function (CHF). The CHF then sends back to the SMF a corresponding Charging Data Response, which may include information regarding how the charging triggers of the SMF is to be configured. In current architectures, the charging triggers are configured either on Rating Group (RG) level or main (PDU) session level. However, as new business use cases emerge in 5G, and as different network slice types may be configured, there is a need for a more flexible way of configuring charging triggers in various NFs.

### SUMMARY

To improve upon currently proposed architectures, the present disclosure provides a method performed by a CHF for assisting in a configuring of charging triggers in an NF, a method performed by an NF for configuring charging triggers thereof, a corresponding CHF entity and NF entity, and corresponding computer programs and computer program products as defined in the accompanying independent claims. Various alternative embodiments of the above methods, entities, computer programs and computer program products are defined in the dependent claims.

According to a first aspect of the present disclosure, a method for assisting in a configuring of charging triggers in an NF is provided. The method is performed by a CHF. The method includes sending a notification message from the CHF to the NF, wherein the message at least indicates one or more charging triggers to be configured by the NF in accordance with the notification message.

Herein, a “notification message” should be understood as a message (such as delivered using a service “notify” operation) which is not a direct response (i.e. a Charging Data Response [Initial or Update]) to a Charging Data Request [Initial or Update] as defined in 3GPP TS 32.290.

That the notification message at least “indicates” one or more charging triggers means that the notification message includes enough information for the NF to deduce therefrom which charging triggers that should be configured. For example, the notification message may include a list/array containing one or more charging triggers, e.g. as a dedicated attribute having a data type suitable therefor. That the charging triggers are to be “configured by the NF in accordance with the notification message” implies that the notification message also includes further information, in addition to the charging triggers themselves, from which the NF may deduce how each respective charging trigger is to be configured in terms of e.g. applicable service sessions, rating groups, and/or network slices for the NF. Herein, that a charging trigger is “configured” may include that the charging trigger is armed, but also (if the notification message so indicates) that the charging trigger is instead updated, or disarmed.

A particular advantage of the disclosed method includes that in, for example, a Charging session initiated by the NF, the CHF may update the configuration of the charging triggers in the NF without first having to wait for e.g. a Charging Data Request from the NF. Instead of having to provide an updated configuration in a Charging Data Response, the CHF can use the notification message to provide the updated configuration whenever it so desires. Phrased differently, the disclosed method allows for the CHF and the NF to communicate and align the charging triggers using a single notification message, based on a decision taken by the CHF.

Another advantage of the disclosed method includes that the charging triggers are no longer bound to e.g. Rating Group and/or main session level (as defined in 3GPP TS 32.290). Instead, the use of the notification message allows configuring one or more charging triggers for e.g. a specific or multiple service sessions, for a specific network slice, or even for a combination of a specific service session and a specific network slice. Charging triggers may be provided and applied e.g. for all the network slices or a single network slice, or all the services sessions over a Package Data Unit (PDU) session. This can provide an improved flexibility and dynamic arming (or update, or disarming) of charging triggers from the CHF based on criteria such as e.g. network slice, Rating Group, etc. When the CHF can update charging triggers in another NF can thus be controlled dynamically in a centric way via e.g. some rating/charging rules, business configuration update or e.g. during special events like festivals, sport events, billing cycles and so on and so forth.

For example, in one or more embodiments of the method, the notification message may indicate that the one or more charging triggers pertain to all service sessions of the NF. This allows to (re-) configure charging triggers for all service sessions of an NF (such as an SMF) using a single notification message.

As another example, in one or more embodiments of the method, the notification message may indicate that the one or more charging triggers pertain to a particular network slice. If an NF is responsible for handling multiple network slices, this allows the CHF to instruct the NF to (re-) configure its charging triggers for a whole network slice using a single notification message. Thus, the charging triggers configured or enabled/armed can be the same for all charging sessions for the particular network slice, and the charging triggers can even be kept between different charging sessions. As different network slices are proposed in future 5G architectures, mapping of charging triggers for the network slice can provide an improved flexibility to handle charging sessions for a particular network slice. Uniformly applying/configuring charging triggers across the network slice may e.g. bring an improved business case to handle charging triggers for the network slice and the services delivered via the network slice.

In one or more embodiments of the method, the method may further include receiving a subscription request to send such notification messages to the NF, and the sending of the notification message may be performed in response to receiving the subscription request. The subscription request may for example be received by the CHF from the NF, which allows the CHF to know that the NF wants to start receiving possible updates to its charging triggers. This can allow to update the charging triggers for e.g. multiple sessions or a segment of subscriber, such as e.g. an IoT segment or a subset of an IoT subscriber segment based on some criteria.

In one or more embodiments of the method, the method may further include determining whether an unsubscription request to stop sending further such notification messages to the NF has been received after receiving the subscription request, and, in response to determining that such an unsubscription request has not been received after receiving the subscription request, sending an additional notification message from the CHF to the NF. Here, the additional notification message may also at least indicate one or more charging triggers to be configured by the NF in accordance with the additional notification message, following the same principle as described above. The use of both the subscription and the unsubscription requests, the CHF can know during what time the NF desires/expects to receive e.g. updated charging triggers, as provided in one or more such additional notification messages.

In one or more embodiments of the method, the NF may be an SMF. For an NF in form of an SMF, the use of the (single) notification message allows the CHF to propagate charging triggers for all service sessions, a particular rating group, a particular network slice, or combinations thereof. This provides a more flexible design approach and may e.g. reduce the number of messages sent between the SMF and the CHF.

In one or more embodiments of the method, the method may include sending the notification message to the SMF via an N40 reference point. This allows to use an interface already available between the CHF and the SMF for communication of the notification message. It is envisaged that also e.g. subscription and unsubscription requests may be sent via such a reference point.

In one or more embodiments of the method, the NF may be one of an Access and Mobility Management Function (AMF) and a Network Exposure Function (NEF). This allows the usage of e.g. non-telecom verticals such as Critical IoT, URLLC, Industrial IoT, or similar.

In one or more embodiments of the method, the method may include exposing an Application Programming Interface (API) for receiving e.g. the explicit subscription request (and also for e.g. receiving an explicit unsubscription request). This may allow the CHF to assist in the configuring of charging triggers in NFs to which there are for example no point-to-point interfaces already available.

According to a second aspect of the present disclosure, a method for configuring charging triggers in an NF is provided. The method is performed by the NF, and includes receiving a notification message from a CHF, wherein the notification message at least indicates one or more charging triggers, and configuring the one or more charging triggers in accordance with the received notification message. The advantages and terminology definitions used for the method of the first aspect apply also to the method of the second aspect.

In one or more embodiments of the method, the method may further include sending, before receiving the notification message, a subscription request to receive such notification messages from the CHF. Phrased differently, the NF can send the subscription request to the CHF in order to control when it desires to receive notification messages from the CHF.

In one or more embodiments of the method, the method may further include sending an unsubscription request to stop receiving further such notification messages from the CHF. Phrased differently, the NF can send the unsubscription request to the CHF in order to control when it no longer desires to receive notification messages from the CHF.

In one or more embodiments of the method, the NF may be an SMF.

In one or more embodiments of the method, the method may include receiving the notification message via an N40 reference point, thereby allowing to use an already existing point-to-point interface between the SMF and the CHF.

In one or more embodiments of the method, the NF may be one of an AMF and an NEF.

In one or more embodiments of the method, the method may include sending the subscription request (and/or e.g. the unsubscription request) via the API exposed by the CHF for receiving such explicit requests (as described earlier herein).

According to a third aspect of the present disclosure, a CHF entity for assisting in a configuring of charging triggers in an NF entity is provided. The CHF entity includes processing circuitry, and the processing circuitry is configured to cause the CHF entity to send a notification message from the CHF entity to the NF entity, wherein the notification message at least indicates one or more charging triggers to be configured by the NF entity in accordance with the notification message. The advantages and terminology definitions used for e.g. the method of the first aspect apply also to the CHF entity of the third aspect.

In one or more embodiments of the CHF entity, the CHF entity may be further configured to perform a method according to any of the embodiments described herein with reference to the method of the first aspect.

According to a fourth aspect of the present disclosure, an NF entity for configuring charging triggers is provided. The NF entity includes processing circuitry. The processing circuitry is configured to cause the NF entity to receive a notification message from a CHF entity, wherein the notification message at least indicates one or more charging triggers, and configure the one or more charging triggers in accordance with the received notification message. The advantages and terminology definitions used for e.g. the method of the second aspect apply also to the NF entity of the fourth aspect.

In one or more embodiments of the NF entity, the NF entity may be further configured to perform a method according to any of the embodiments described herein with reference to the method of the second aspect.

According to a fifth aspect of the present disclosure, a computer program for assisting in a configuring of charging triggers in an NF entity is provided. The computer program includes computer code which, when run on processing circuitry of a CHF entity, causes the CHF entity to send a notification message from the CHF entity to the NF entity, wherein the notification message at least indicates one or more charging triggers to be configured by the NF entity in accordance with the notification message. The advantages and terminology definitions used for e.g. the method of the first aspect apply also to the computer program of the fifth aspect.

According to a sixth aspect of the present disclosure, a computer program product is provided. The computer program product includes a computer program according to the fifth aspect, and a computer readable storage medium on which the computer program is stored.

According to a seventh aspect of the present disclosure, a computer program for configuring charging triggers in an NF entity is provided. The computer program includes computer code which, when run on processing circuitry of an NF entity, causes the NF entity to receive a notification message from a CHF entity, wherein the notification message at least indicates one or more charging triggers, and configure the one or more charging triggers in accordance with the received notification message. The advantages and terminology definitions used for e.g. the method of the second aspect apply also to the computer program of the seventh aspect.

According to an eight aspect of the present disclosure, a computer program product is provided. The computer program product includes a computer program according to the seventh aspect, and a computer readable storage medium on which the computer program is stored.

Other objects and advantages of the present disclosure will be apparent from the following detailed description, the drawings and the claims. Within the scope of the present disclosure, it is envisaged that all features and advantages described with reference to e.g. the method of the first aspect are relevant for, apply to, and may be used in combination with also the method of the second aspect, the entities of the third and fourth aspects, the computer programs of the fifth and seventh aspects, and the computer program products of the sixth and eight aspects, and vice versa.

### BRIEF DESCRIPTION OF THE DRAWINGS

Exemplifying embodiments will be described below with reference to the accompanying drawings, in which:

FIG. 1 schematically illustrates parts of a communication network relevant for the present disclosure;

FIG. 2 schematically illustrates the flow of various embodiments of a method according to the present disclosure,

FIG. 3 schematically illustrates the flow of various embodiments of another method according to the present disclosure;

FIGS. 4a-4d schematically illustrate sequence flows of various embodiments of the present disclosure;

FIGS. 5a and 5b schematically illustrate various embodiments of CHF entities according to the present disclosure

FIGS. 6a and 6b schematically illustrate various embodiments of NF entities according to the present disclosure, and

FIG. 7 schematically illustrates various embodiments of computer program products according to the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested.

### DETAILED DESCRIPTION

Exemplifying embodiments of the various methods, entities, computer programs and computer program products according to the present disclosure will now be described more fully hereinafter with reference to the accompanying drawings. The drawings show only certain embodiments of the present disclosure. The invention of the present disclosure may, however, be embodied in many different forms and should not be construed as limited to the embodiments set forth herein; rather, these embodiments are provided for thoroughness and completeness, and fully convey the scope of the present disclosure to the skilled person.

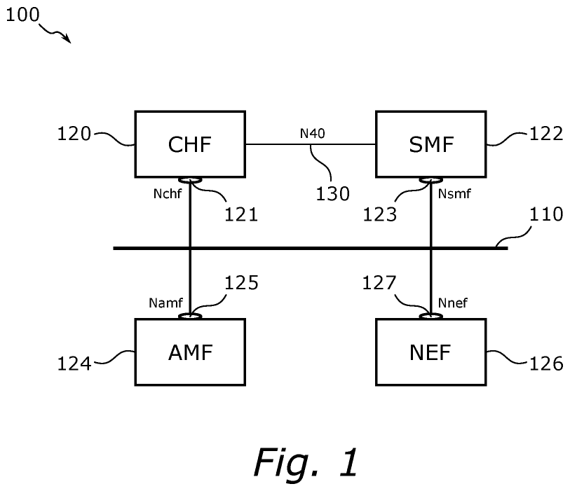

The embodiments presented herein can be applied in a communication network such as e.g. a public land mobile network (PLMN). More in particular, it is envisaged that the embodiments presented herein apply at least to a reference architecture of a fifth-generation telecommunication system (5GS), and parts of such a network especially relevant for the present disclosure will now be described in more detail with reference to FIG. 1.

FIG. 1 schematically illustrates part of a communication network 100, including several Network Functions (NFs) 120, 122, 124, 126 connected together via a Service-Based Interface (SBI) topology built around a common communication bus 110. The NFs are respectively a CHF 120, an SMF 122, an AMF 124, and a NEF 126. The network 100 may of course also include multiple other/additional NFs, but for the purpose of avoiding obfuscation of the core idea behind the present disclosure, these are not illustrated in FIG. 1. Each one of the NFs 120, 122, 124 and 126 has its own SBI 121, 123, 125, 127, respectively, indicated in text on the format “Nxyz”, where “xyz” is the abbreviation for the corresponding NF (such as Nchf for the CHF 120, Nsmf for the SMF 122, and so on). There is also a point-to-point interface 130, indicated in text as “N40”, which connects the CHF 120 and the SMF 122. There may of course be other such point-to-point interfaces available, but these have on purpose been omitted from FIG. 1. One or more of the NFS 120, 122, 124, 126 may also have further connections also not shown in FIG. 1. For example, the illustrated NFs all form part of a Control Plane, and e.g. the SMF 122 and the AMF 124 may each have connections (via e.g. other point-to-point interfaces, not shown) to one or more functions of a User Plane. For more details, see e.g. 3GPP TS 23.501.

It is envisaged that the CHF 120 forms part of a so-called Converged Charging System (CCS) which may in turn interact with a billing system of e.g. a network operator running the network 100. The CHF 120 is responsible for both online and offline charging in a convergent manner, and operates to collect data on e.g. network resource usage from e.g. the SMF 122. To do so, the CHF 120 may provide a service Nchf_ConvergedCharging, including operations such as Create, Update and Release (as specified in 3GPP TS 32.291). The CHF 120 may also provide other services, such as e.g. Nchf_SpendingLimitControl (as specified in 3GPP TS 23.502). Using a resource and data model, all operations of e.g. the Nchf_ConvergedCharging are based on a HTTP method such as e.g. POST and DELETE. More details on how the CHF 120, according to already proposed architectures, interacts with e.g. the SMF 122 is found in 3GPP TS 32.290.

As described earlier herein, an NF such as the SMF 122 may indicate to the CHF 120 that it wants to initiate a Charging Session. To do so, the SMF 122 may send a Charging Data Request [Initial] to the CHF 120, which may respond back with a Charging Data Response [Initial]. To know which events that are to be monitored, the SMF 122 uses one or more charging triggers. As soon as such a charging trigger is activated, the SMF 122 sends another Charging Data Request [Update] to the CHF 120, informing the CHF 120 of which charging trigger that was activated, and e.g. together with for example a current data usage count or similar, such that the CHF 120 may properly handle the bookkeeping needed to keep track of e.g. the network data usage, service usage, etc., for which the user is to be billed. The CHF 120 may assist in configuring the charging triggers of the SMF 122 by providing a list of what charging triggers it wants the SMF 122 to use. As specified in 3GPP TS 32.291, such a list may be provided by the CHF 120 to the SMF 122s either in the response to the Charging Data Request [Initial], or in the response to the later Charging Data Request [Update], from the SMF 122. Each such list includes or is accompanied by details whether the charging triggers are to be applied on a Rating Group level or on a main (PDU) session level.

However, for the reasons described earlier herein in e.g. the section “Summary”, such a current architecture may not provide sufficient flexibility in situations where there are for example multiple network slices, and where e.g. the SMF 122 is responsible for handling more than one network slice.

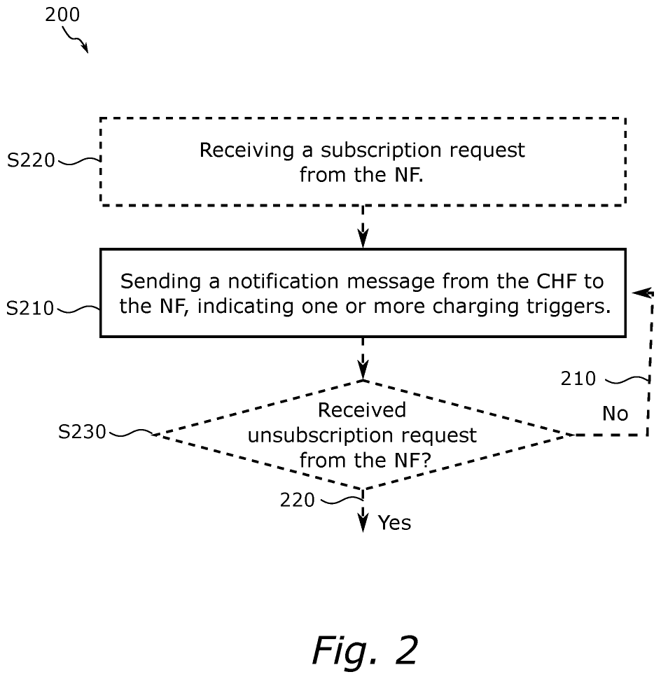

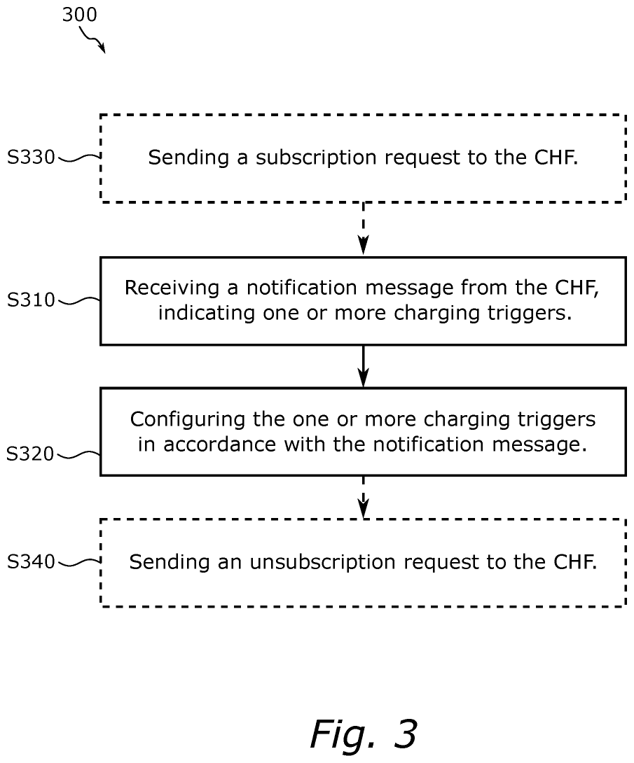

Thus, the present disclosure provides improved methods for (assisting in the) configuring of the charging triggers for an NF (such the SMF 122). As will now be described in more detail with reference to FIGS. 2 and 3, the present disclosure proposes to instead provide charging triggers to an NF from the CHF using a notification message.

FIG. 2 schematically illustrates a flow of one embodiment of a method 200 for assisting in a configuring of charging triggers in an NF. The method 200 is performed by the CHF 120 of FIG. 1. In a step S210, the CHF 120 sends a notification message, where the notification message at least indicates one or more charging triggers to be configured by the NF in accordance with the notification message. As described earlier herein, the NF may for example be an SMF, an AMF or an NEF, or other types of NFs that needs to have their charging triggers configured.

In some embodiments of the method 200, the step S210 is preceded by another step s220, which includes first receiving (e.g. from the NF) a subscription request to send such notification messages to the NF. Thus, in such an embodiment of the method 200, the step s210 of sending the notification message to the NF is performed in response to receiving the subscription request.

In some embodiments of the method 200, the step S210 of sending the notification message is succeeded by a step S230, wherein the method 200 determines whether an unsubscription request to stop sending further such notification messages to the NF has been received after receiving the subscription request. If it is determined that such an unsubscription request has not been received after receiving the subscription request, the method 200 proceeds by sending an additional notification message from the CHF 120 to the NF. This can, as indicated by the arrow 210, be performed by repeating the step S210 of sending the notification message to the NF. Of course, the additional notification message sent by repeating step S210 may of course be different from the first notification message, and may e.g. indicate different charging triggers to be configured by the NF in accordance with the additional notification message, etc. Once the additional notification message has been sent, it is envisaged that the method 200 may proceed by once again checking whether an unsubscription request has been received from the NF, and thereafter act accordingly by either sending yet another notification message to the NF (arrow 210), or by (if the unsubscription request has in fact been received) stop sending further notification messages to the NF (arrow 220). Although not shown in FIG. 1, it is envisaged that once an unsubscription request is received from the NF, the method 200 may also proceed by waiting for a new subscription request to arrive from the NF, and then repeat steps S220 and S210.

As further indicated by the boxes of the steps S220 and S230 being dashed, it should be noted that in one or more embodiments of the method 200, the steps S220 and S230 related to subscription/unsubscription requests can be optional, and it is envisaged that the CHF 120 can then send one or more notification messages to the NF without a subscribe/unsubscribe procedure initiated by the NF.

FIG. 3 schematically illustrates a flow of one embodiment of a method 300 for configuring charging triggers in an NF. The method 300 is performed by the NF, such as e.g. the SMF 122, the AMF 124 and/or the NEF 126 of FIG. 1, or other NFs which need to have their charging triggers configured. In a step S310, the NF receives a notification message from the CHF 120, where the notification message at least indicates one or more charging triggers. In a subsequent step S320, the method 300 proceeds by configuring the one or more charging triggers in accordance with the received notification message.

In some embodiments of the method 300, the step S310 may be proceeded by a step s330, wherein a subscription request to receive such notification messages from the CHF 120 is first sent from the NF to the CHF 120.

In some embodiments of the method 300, the step S320 can be succeeded by a step S340, in which an unsubscription request to stop receiving further such notification messages from the CHF 120 is sent from the NF to the CHF 120.

Although not illustrated in FIG. 3, it is envisaged also that the method 300, in some embodiments, can include repeating steps S310 and S320 such that multiple notification messages are received from the CHF 120. The start and stop of such repeated receival of notification messages can be controlled by the use of subscription and unsubscription requests to the CHF 120 as performed in steps S330 and S340, respectively.

As further indicated by the boxes of the steps S330 and S340 being dashed, it should be noted that in one or more embodiments of the method 300, the steps S330 and S340 related to subscription/unsubscription requests can be optional, and it is envisaged that the NF can then receive one or more notification messages from the CHF 120 without a subscribe/unsubscribe procedure initiated by the NF.

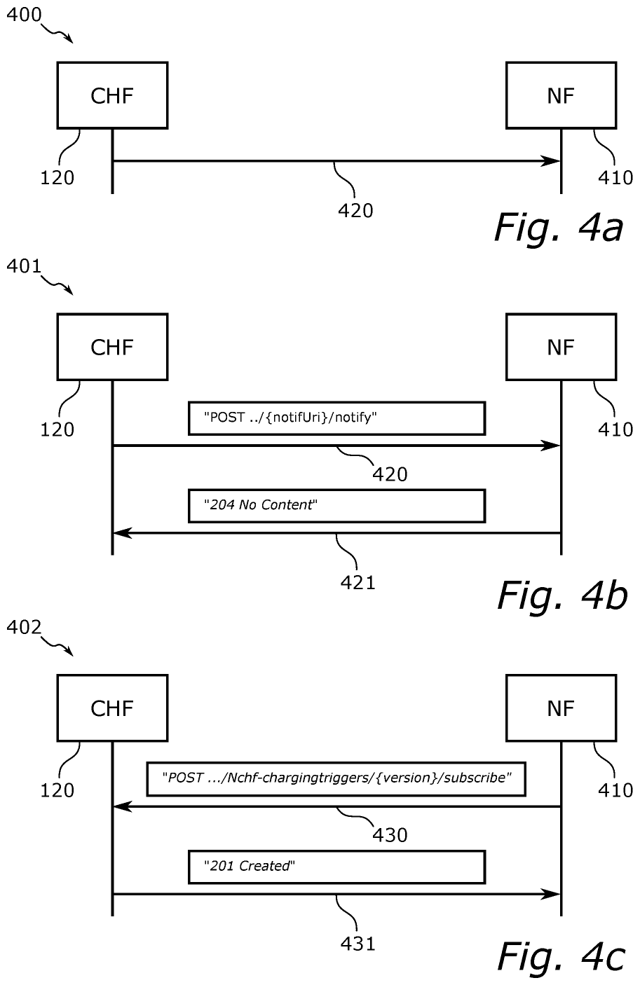

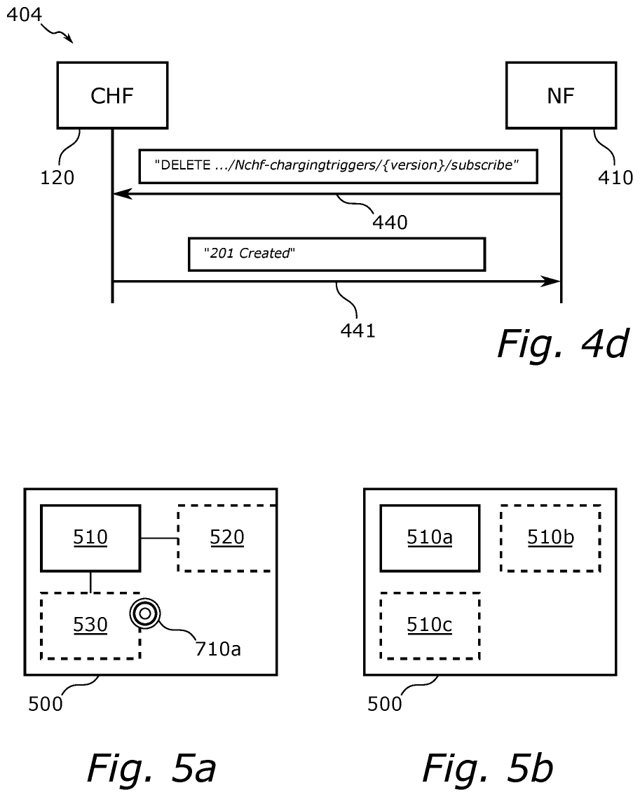

Various embodiments of sending and receiving notification messages for configuring of charging triggers in an NF, applicable to the various methods disclosed herein, will now be described in more detail with reference to FIGS. 4a-4d.

FIG. 4a schematically illustrates a sequence flow of an example embodiment 400, wherein the CHF 120 sends a notification message 420 to the NF 410. As will be described in more detail later herein, the sending of the notification message 420 can in some cases also involve the NF 410 first subscribing to such notification messages from the CHF 120, and also that the NF 410 then unsubscribes to stop receiving further notification messages from the CHF 120. If the NF 410 is the SMF 122, it is envisaged that the notification message 420 can be sent using e.g. the N40 point-to-point interface already available and connecting the CHF 120 with the SMF 122. If the NF 410 is some other NF for which there exists no predefined point-to-point interface to the CHF 120, messages may be exchanged using e.g. various APIs exposed on the SBI common bus.

In this and other embodiments described herein, the notification message 420 can include e.g. a list of updated charging triggers applicable to service sessions for the NF 410. In accordance with the received notification message 420, the NF 410 should then configure its charging triggers to the relevant service sessions and for e.g. a particular network slice if that is indicated in the notification message. By so doing, the NF 410 and the CHF 120 can advantageously communicate and align the charging triggers with a single notification message based on a decision taken by the CHF 120. As described earlier herein, for example, if the CHF 120 decides that it wants to update e.g. the currently armed charging triggers of the NF 410, the CHF 120 does not first have to wait for an incoming Charging Data Request [Update] from the NF 410, but can directly perform such an update by sending the notification message 420 to the NF 410.

Although not illustrated in FIG. 4a, it is envisaged that, after having received the notification message 420, the NF 410 can confirm the receival by sending back a confirmation message to the CHF 120.

FIG. 4b schematically illustrates a sequence flow of an example embodiment 401, wherein the CHF 120 sends the notification message 420 using a HTTP POST method. The target of the notification message 420 is provided by the NF 410 to the CHF 120 as a resource variable “notifyUri”, which may be included for example in a first Charging Data Request [Initial] sent from the NF 410 to the CHF 120 in order to initiate a Charging Session. In other examples, such as those involving explicit subscribe/unsubscribe procedures as envisaged herein, the resource variable “notifyUri” may e.g. be provided by the NF 410 to the CHF 120 in a subscription request. The NF 410 may for example, at this Uri, provide an operation/method “notify” for the CHF 120 to use in order to deliver the notification message 420 to the NF 410.

After having received the notification message 420 from the CHF 120, the NF 410 responds by sending back a message 421, for example a “204 No Content”.

FIG. 4c schematically illustrates a sequence flow of an example embodiment 402, wherein the NF 410 first sends a subscription request 430 to the CHF 120, indicating that the NF 410 wants to receive one or more notification messages from the CHF 120. The subscription request 433 is performed using a new API exposed by the CHF 120 on the SBI common data bus, for receiving such explicit subscription requests from various NFs. The subscription request 430 may be sent to the CHF 120 using a HTTP POST method, targeting a service for subscription provided by the new API. The new API may for example provide an operation/method “subscribe” for receiving explicit subscription requests from the NF 410. More details of such a new API will be provided later herein.

After having received the explicit subscription request 430 from the NF 410, the CHF 120 responds by sending back e.g. a “201 Created” message 431, which may also at least indicate one or more charging triggers that are to be configured by the NF 410 in accordance with the response message 431. The CHF 120 may then also start to provide one or more notification messages to the NF 410, as described herein with reference e.g. to FIGS. 4a and 4b.

FIG. 4d schematically illustrates a sequence flow of an example embodiment 403, wherein the NF 410 informs the CHF 120 that it no longer wants to receive further notification messages, by sending an unsubscription request 440 to the CHF 120. The unsubscription request 440 is also made using the new API exposed by the CHF 120, which can also be configured for receiving such explicit unsubscription requests from various NFs. The unsubscription request 440 may be sent to the CHF 120 using a HTTP DELETE method, targeting a service for unsubscription provided by the new API. The new API may for example provide an operation/method “unsubscribe” for receiving explicit unsubscription requests from the NF 410.

Herein, it is also envisaged that the NF may be e.g. an AMF or a NEF, and the AMF/NEF can use the subscribe/unsubscribe procedure via the new API to get e.g. also event-based charging triggers from the CHF. This in contrast to current architectures, wherein NEF/AMF instead has to rely on an Operations Support System (OSS) in order to receive such triggers. Using the solution as provided in the present disclosure, the NEF/AMF may for example get generic charging triggers from the CHF for multiple subscribers over a single subscription request/session. These charging triggers may be generic such that they may be controlled for a segment of IoT users. In the proposed solution, charging triggers are handled in a more centralized control manner, i.e. with CHF-based control.

A notification message as envisaged herein, and as used in the described embodiments, can for example include the parameters shown in Table 1, for the “notify” operation/method provided by the NF.

TABLE 1
Example message and parameters for operation/method “notify”.

| Attribute | | | Cardi- | |
|---|---|---|---|---|
| name | Data type | P | nality | Description |
| ratingGroup | RatingGroup | O_{C} | o . . . 1 | Rating group for which the |
| | | | | charging triggers should be |
| | | | | enforced |
| triggers | array(Trigger) | O_{C} | o . . . N | This field identifies the |
| | | | | chargeable event(s) |
| | | | | supplied by the CHF to |
| | | | | override/activate the |
| | | | | existing chargeable event(s) |
| | | | | in the NF consumer. |
| | | | | The presence of the triggers |
| | | | | attribute without any |
| | | | | triggerType can be used by |
| | | | | the CHF to disable all the |
| | | | | triggers except rating group |
| | | | | level triggers. |
| sNSSAI | SNSSAI | O_{C} | 1 | Specifies for which specific |
| | | | | network slice session the |
| | | | | triggers should apply. |

In the above Table 1, both the parameters “ratingGroup” and “sNSSAI” are optional. In some embodiments, leaving out both Rating Group and network slice information from the notification message can indicate to the receiving NF that the charging triggers should apply to all the service sessions of the NF. In some embodiments, the network slice can be included, indicating to the receiving NF that the charging triggers should apply to all the service sessions of the NF for the particular network slice. In some embodiments, the Rating Group can be included, indicating to the receiving NF that the charging triggers should apply to a particular Rating Group. Of course, other combinations are also possible, such as providing both a Rating Group and a network slice in the notification message, etc. The parameters described above (as shown in Table 1) are further explained in 3GPP TS 32.291.

It should be noted that the notification message as envisaged herein, an example of which is provided in the above Table 1, is different from e.g. the type “ChargingNotifyRequest” specified in 3GPP TS 32.291. In “ChargingNotifyRequest”, the CHF only asks the NF to perform a re-authorization (i.e. to send a new Charging Data Request) to the CHF, and it is only after receiving such a re-authorization from the NF that the CHF can provide e.g. updated charging triggers to the NF. In contrast, the notification message as illustrated in Table 1 includes all information needed for the CHF to provide/update charging triggers to the NF, and thus only a single message needs to be transferred.

As mentioned earlier herein, it is envisaged that in some embodiments, the CHF may expose a new API which can be used by the NF to e.g. subscribe/unsubscribe from receiving charging triggers via the notification message. Such an API may for example provide a new service “Nchf-chargingtriggers”, and include the operations/methods shown in Table 2.

TABLE 2
Operations/methods provided by new API Nchf-chargingtriggers.

| Service | | |
|---|---|---|
| operation/method | HTTP method | Description |
| /subscribe | POST | Method used by the NF to |
| | | register for receiving |
| | | charging triggers form the |
| | | CHF. |
| /unsubscribe | DELETE | Method used by the NF to |
| | | stop receiving charging |
| | | triggers from the CHF. |

When using the new API to make a subscription request, the initiating NF should provide sufficient information for the receiving CHF to deduce which NF is making the request. For example, the NF can provide a parameter of the type NFIdentification as specified in 3GPP TS 32.291. If applicable, the NF may also provide network slice information to the CHF to deduce which particular network slice the NF is associated with. For example, the NF can provide a parameter of the type SNSSAI as also specified in 3GPP TS 32.291. If making an unsubscription request, the NF should provide sufficient information such that the CHF can deduce which NF that is making the unsubscription request. For this purpose, as an example, the NF can include a parameter of the type NFIdentification as specified in 3GPP TS 32.291.

When slice-based charging is enabled on the CHF, several charging triggers may be configured per network slice level using the proposed notification message. As mentioned earlier herein, this can provide more flexible and adaptable charging triggers for the charging system. For a network slice of the eMBB type, such charging triggers may for example include: QUOTA_THRESHOLD, VOLUME_LIMIT, QHT, VALIDITY_TIME, FORCED_REAUTHORISATION, QOS_CHANGE, SESSION_AMBR_CHANGE, GFBR_GUARANTEED_STATUS_CHANGE, TARIFF_TIME_CHANGE, MAX_NUMBER_OF_CHANGES_IN_CHARGING_CONDITIONS, and RAT_CHANGE. For a network slice of the URLLC type, such charging triggers may for example include: QOS_CHANGE, TAI_CHANGE, HANDOVER_START, HANDOVER_CANCEL, HANDOVER_CANCEL, PLMN_CHANGE, and TIME_LIMIT. For a network slice of the MIT type, such charging triggers may for example include: QUOTA_THRESHOLD, VALIDITY_TIME, QOS_CHANGE, TIME_LIMIT, EVENT_LIMIT, USER_LOCATION_CHANGE, and ECGI_CHANGE. For a network slice of the V2X type, such charging triggers may for example include: QUOTA_THRESHOLD, QOS_CHANGE, TIME_LIMIT, GFBR_GUARANTEED_STATUS_CHANGE, UE_TIMEZONE_CHANGE, TAI_CHANGE, and ECGI_CHANGE. Other charging triggers may also be used for these and other types of network slices.

Operators may also have the possibility to configure custom specific network slices based on e.g. various business needs and even in collaboration with other (telecom) operators. Non-standard network slices may e.g. be provisioned by customers. For an Enterprise Network slice, the charging triggers may for example include: QUOTA_THRESHOLD, QUOTA_EXHAUSTED, VALIDITY_TIME, VOLUME_LIMIT, TAI_CHANGE, RAT_CHANGE, MAX_NUMBER_OF_CHANGES_IN_CHARGING_CONDITIONS, and SERVING_NODE_CHANGE. For a Critical IoT network slice, the charging triggers may for example include: VALIDITY_TIME, TIME_LIMIT, EVENT_LIMIT, GFBR_GUARANTEED_STATUS_CHANGE, and SERVING_NODE_CHANGE. For an Industrial IoT network slice, the charging triggers may for example include: QUOTA_THRESHOLD, QUOTA_EXHAUSTED, QOS_CHANGE, VOLUME_LIMIT, and GFBR_GUARANTEED_STATUS_CHANGE. Other charging triggers may also be used for custom network slices. It should be noted that the examples of charging triggers provided in this and the preceding paragraph are provided for illustrative purposes only, and that it is envisaged that the exact charging triggers may be different depending on specific needs, and/or that the charging triggers may apply also for other network slice types not listed in the paragraphs.

A CHF entity for performing the method of assisting in a configuring of charging triggers in an NF will now be described in more detail with reference to FIGS. 5a and 5b.

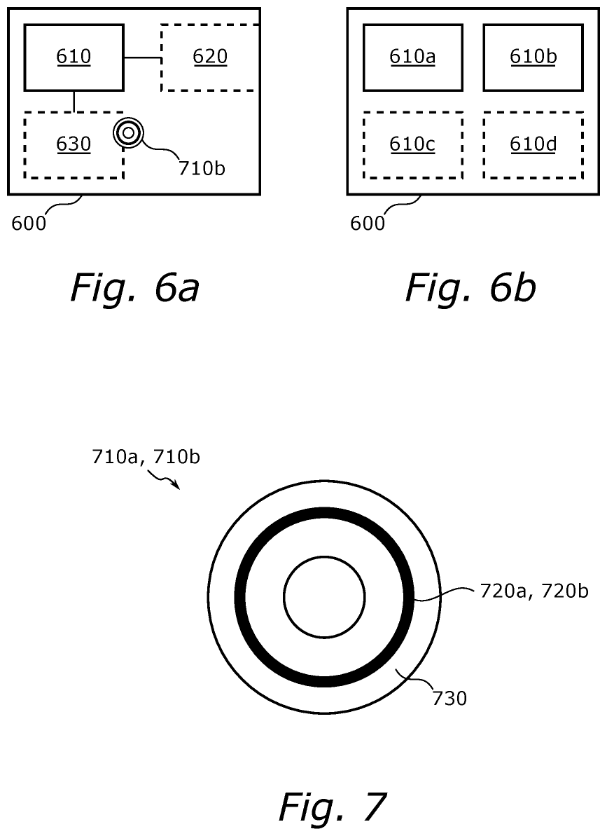

FIG. 5a schematically illustrates, in terms of a number of functional units, the components of an embodiment of a CHF entity 500 according to the present disclosure. The CHF entity 500 is configured for assisting in a configuring of charging triggers in an NF entity (as will be described later with reference to FIGS. 6a and 6b), and includes processing circuitry 510. The processing circuitry 510 is provided using any combination of one or more of a suitable central processing unit (CPU), multiprocessor, microcontroller, digital signal processor (DSP), etc., capable of executing software instructions stored in a computer program product 700a (see FIG. 7 and the description thereof), e.g. in form of a storage medium 530. The processing circuit 510 may further be provided as at least one application specific integrated circuit (ASIC), or field-programmable gate array (FPGA).

Particularly, the processing circuitry 510 is configured to cause the CHF entity 500 to perform a set of operations, or steps, as disclosed above e.g. when describing the method 200 illustrated in FIG. 2. For example, the storage medium 530 may store a set of operations, and the processing circuitry 510 may be configured to retrieve the set of operations from the storage medium 530 to cause the CHF entity 500 to perform the set of operations. The set of operations may be provided as a set of executable instructions. Thus, the processing circuitry 510 is thereby arranged to execute methods as disclosed herein e.g. with reference to FIG. 2.

The storage medium 530 may also include persistent storage, which, for example, can be any single or combination of magnetic memory, optical memory, solid state memory or even remotely mounted memory.

The CHF entity 500 may further include a communications interface 520 for communications with other entities, functions, nodes, and devices of the communication network. For example, the communications interface 520 may allow the CHF entity 500 to communicate with e.g. an SMF, an AMF or an NEF entity, and/or with other NFs. As such, the communication interface 520 may include one or more transmitters and receivers, including analogue and/or digital components.

The processing circuitry 510 controls the general operation of the CHF entity 500 e.g. by sending data and control signals to the communications interface 520 and the storage medium 530, by receiving data and reports from the communications interface 520, and by retrieving data and instructions from the storage medium 530. Other components, as well as their related functionality, of the CHF entity 500 are omitted in order not to obscure the concepts presented herein.

FIG. 5b schematically illustrates, in terms of a number of functional modules 510a, 510b and 510c, the components of a CHF entity 500 according to one embodiment of the present disclosure. The CHF entity 500 includes at least a send module 510a configured to perform step S210 of the method 200 described with reference to FIG. 2. The CHF entity 500 may also include one or more optional functional modules, such as for example: at least a receive module 510b configured to perform step S220 of the method 200, and/or at least a confirmation module 510c configured to perform step S230 of the method 200. If one or more of these additional/optional steps S220 and S230 of the method 200 are not included, it is envisaged that the CHF entity 500 does not require the corresponding functional blocks/modules 510b and 510c, or at least that these may still be included but put in an inactive state or similar.

In general terms, each functional module 510a, 510b and 510c may be implemented in hardware or in software. Preferably, one or more or all functional modules 510a, 510b, 510c may be implemented by the processing circuitry 210, possibly in cooperation with the communications interface 520 and/or the storage medium 530. The processing circuitry 510 may thus be arranged to from the storage medium 530 fetch instructions as provided by a functional module 510a, 510b and 510c, and to execute these instructions and thereby perform any steps of the CHF entity 500 as disclosed herein.

An NF entity for configuring charging triggers thereof is now described in more detail with reference to FIGS. 6a and 6b.

FIG. 6a schematically illustrates, in terms of a number of functional units, the components of an embodiment of an NF entity 600 according to the present disclosure. The NF entity 600 is configured for configuring charging triggers thereof, and includes processing circuitry 610. The processing circuitry 610 is provided using any combination of one or more of a suitable central processing unit (CPU), multiprocessor, microcontroller, digital signal processor (DSP), etc., capable of executing software instructions stored in a computer program product 700b (see FIG. 7 and the description thereof), e.g. in form of a storage medium 630. The processing circuit 610 may further be provided as at least one application specific integrated circuit (ASIC), or field-programmable gate array (FPGA).

Particularly, the processing circuitry 610 is configured to cause the NF entity 600 to perform a set of operations, or steps, as disclosed above e.g. when describing the method 300 illustrated in FIG. 3. For example, the storage medium 630 may store a set of operations, and the processing circuitry 610 may be configured to retrieve the set of operations from the storage medium 630 to cause the NF entity 600 to perform the set of operations. The set of operations may be provided as a set of executable instructions. Thus, the processing circuitry 610 is thereby arranged to execute methods as disclosed herein e.g. with reference to FIG. 3.

The storage medium 630 may also include persistent storage, which, for example, can be any single or combination of magnetic memory, optical memory, solid state memory or even remotely mounted memory.

The CHF entity 600 may further include a communications interface 620 for communications with other entities, functions, nodes, and devices of the communication network. For example, the communications interface 620 may allow the NF 600 to communicate with e.g. a CHF, and/or also with other NFs. As such, the communication interface 620 may include one or more transmitters and receivers, including analogue and/or digital components.

The processing circuitry 610 controls the general operation of the NF entity 600 e.g. by sending data and control signals to the communications interface 620 and the storage medium 630, by receiving data and reports from the communications interface 620, and by retrieving data and instructions from the storage medium 630. Other components, as well as their related functionality, of the NF entity 600 are omitted in order not to obscure the concepts presented herein.

FIG. 6b schematically illustrates, in terms of a number of functional modules 610a-610d, the components of an NF entity 600 according to one embodiment of the present disclosure. The NF entity 600 includes at least a receive module 610a configured to perform step S310 of the method 300 described with reference to FIG. 3. The NF entity 600 also includes at least a configure module 610b configured to perform step S320 of the method. The NF entity 600 may also include one or more optional functional modules, such as for example: at least a (subscribe) send module 610c configured to perform step S330 of the method 300, and/or at least a (unsubscribe) send module 610d configured to perform step S340 of the method 300. If one or more of these additional/optional steps S330 and S340 of the method 300 are not included, it is envisaged that the NF entity 600 does not require the corresponding functional blocks/modules 610c and/or 610d, or at least that these may still be included but put in an inactive state or similar.

In general terms, each functional module 610a-610d may be implemented in hardware or in software. Preferably, one or more or all functional modules 610a-610d may be implemented by the processing circuitry 610, possibly in cooperation with the communications interface 620 and/or the storage medium 630. The processing circuitry 610 may thus be arranged to from the storage medium 630 fetch instructions as provided by a functional module 610a-610d, and to execute these instructions and thereby perform any steps of the NF entity 600 as disclosed herein.

The CHF entity/NF entity may be provided as a standalone device or as part of at least one further device. For example, the CHF entity/NF entity may be provided in a node of the core network. Alternatively, functionality of the CHF entity/NF entity may be distributed between at least two devices, or nodes. These at least two nodes, or devices, may either be part of the same network part (such as e.g. the core network) or may be spread between at least two such network parts. For example, instructions that are required to be executed in real time may be performed in a device, or node, operatively closer to e.g. the cell than instructions that are not required to be performed in real time. In this respect, at least part of the CHF entity/NF entity may reside in the radio access network, such as in the radio access network node, for cases when embodiments as disclosed herein are performed in real time.

Thus, a first portion of the instructions performed by the CHF entity/NF entity may be executed in a first device, and a second portion of the instructions performed by the CHF entity/NF entity may be performed in a second device. The herein disclosed embodiments are however not limited to any particular number of devices on which the instructions performed by the CHF entity/NF entity may be executed. Hence, the methods according to the herein disclosed embodiments are suitable to be performed by a CHF entity/NF entity residing in a cloud computational environment. Therefore, although e.g. a single processing circuitry 510 and 610 is illustrated in each of FIGS. 5a and 6a, the processing circuitry 510 and 610 may be distributed among a plurality of devices, or nodes. The same applies also to the various functional modules 510a-c and 610a-d of FIGS. 5b and 6b and the computer programs 720a and 720b of FIG. 7s.

Various computer program products according to the present disclosure will now be described in more detail with reference to FIG. 7.

FIG. 7 schematically illustrates a computer program product 710a, 710b including computer readable means 730. On the computer readable means 730, a computer program 720a can be stored, which computer program 720a can cause the processing circuitry 510 and thereto operatively coupled entities and devices, such as the communication interface 520 and the storage medium 530, to execute method 200 according to embodiments described herein with reference to FIG. 2. The computer program 720a and/or computer program product 710a may thus provide means for performing any steps of the CHF entity as herein disclosed. On the computer readable means 730, a computer program 720b can also be stored, either in addition to or instead of the computer program 720a, which computer program 720b can cause the processing circuitry 610 and thereto operatively coupled entities and devices, such as the communication interface 620 and the storage medium 630, to execute method 300 according to embodiments described herein with reference to FIG. 3. The computer program 720b and/or computer program product 710b may thus provide means for performing any steps of the NF entity as herein disclosed.

In the example of FIG. 7, the computer program product 710a, 710b is illustrated as an optical disc, such as a CD (compact disc) or a DVD (digital versatile disc) or a Blu-Ray disc. The computer program product 710a, 710b could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720a, 720b is here schematically shown as a track on the depicted optical disk, the computer program 720a, 720b can be stored in any way which is suitable for the computer program product 710a, 710b.

In summary, the present disclosure presents a way of allowing the CHF to assist in the configuring of charging triggers in various NFs, using a notification message instead of having to wait for e.g. responding to a Charging Data Request from the NF. This avoids the CHF having to wait for such a request, and the operator and the CHF is given more control on how to dynamically (re-) configure the charging triggers dynamically. This is important, as charging triggers play a critical role in rating conditions and what events to be applied for session-based charging or event-based charging, and the present disclosure therefore provides an improvement in this field. A single notification message can for example assist in arming charging triggers for e.g. an SMF for all its service sessions, ratings groups and/or for a particular network slice. This helps to reduce the number of messages sent between e.g. the CHF and SMF. For network slice-based charging, the possibility to also specify a particular network slice in the notification message allows an improved way of mapping charging triggers, and provides a more flexible way of handling charging sessions for a given network slice. By providing a new API for subscription/unsubscription, the proposed solution also offers other network functions such as AMF/NEF to receive charging trigger information directly from the CHF.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

1. A method for assisting in a configuring of charging triggers in a Network Function, NF, the method being performed by a Converged Charging Function, CHF, the method comprising:
sending a notification message from the CHF to the NF, wherein the notification message at least indicates one or more charging triggers to be configured by the NF in accordance with the notification message.

2. The method according to claim 1, wherein the notification message indicates that the one or more charging triggers pertain to all service sessions of the NF.

3. The method according to claim 1, wherein the notification message indicates that the one or more charging triggers pertain to a particular network slice.

4. The method according to claim 1, further comprising receiving a subscription request to send notification messages to the NF, and wherein the sending of the notification message is performed in response to receiving the subscription request.

5. The method according to claim 4, further comprising:
determining whether an unsubscription request to stop sending further notification messages to the NF has been received after receiving the subscription request, and
in response to determining that an unsubscription request has not been received after receiving the subscription request, sending an additional notification message from the CHF to the NF,
wherein the additional notification message also at least indicates one or more charging triggers to be configured by the NF in accordance with the additional notification message.

6. The method according to claim 1, wherein the NF is a Session Management Function, SMF.

7. The method according to claim 6, comprising sending the notification message to the SMF via an N40 reference point.

8. The method according to claim 1, wherein the NF is one of an Access and Mobility Management Function, AMF, and a Network Exposure Function, NEF.

9. The method according to claim 4, comprising exposing an Application Programming Interface, API, for explicitly receiving the subscription request.

10. A method for configuring charging triggers in a Network Function, NF, the method being performed by the NF, the method comprising:
receiving a notification message from a Converged Charging Function, CHF, wherein the notification message at least indicates one or more charging triggers, and
configuring the one or more charging triggers in accordance with the received notification message.

11. The method according to claim 10, further comprising sending, before receiving the notification message, a subscription request to receive notification messages from the CHF.

12. The method according to claim 10, further comprising sending an unsubscription request to stop receiving further notification messages from the CHF.

13. The method according to claim 10, wherein the NF is a Session Management Function, SMF.

14. The method according to claim 13, comprising receiving the notification message via an N40 reference point.

15. The method according to claim 10, wherein the NF is one of an Access and Mobility Management Function, AMF, and a Network Exposure Function, NEF.

16. The method according to claim 10, comprising sending the subscription request via an Application Programming Interface, API, exposed by the CHF for explicitly receiving the subscription request.

17. A converged Charging Function, CHF, entity for assisting in a configuring of charging triggers in a Network Function, NF, entity, the CHF entity comprising processing circuitry, the processing circuitry being configured to cause the CHF entity to:
send a notification message from the CHF entity to the NF entity, wherein the notification message at least indicates one or more charging triggers to be configured by the NF entity in accordance with the notification message.

18. The CHF entity according to claim 17, further being configured to receive a subscription request to send notification messages to the NF, and wherein the sending of the notification message is performed in response to receiving the subscription request.

19. A Network Function, NF, entity for configuring charging triggers, the NF entity comprising processing circuitry, the processing circuitry being configured to cause the NF entity to:
receive a notification message from a Converged Charging Function, CHF, entity, wherein the notification message at least indicates one or more charging triggers, and
configure the one or more charging triggers in accordance with the received notification message.

20. The NF entity according to claim 19, further being configured to send, before receiving the notification message, a subscription request to receive notification messages from the CHF.

21-24. (canceled)
